(19) United States
(12) Patent Application Publication
(10) Pub. No.: US 2010/0108786 A1
(43) Pub. Date: May 6, 2010

(54) FUEL INJECTOR ASSEMBLY

(76) Inventors: VENU GUMMADAVELLI, Columbia, SC (US); Steffen Martin, Columbia, SC (US); Bernd Niethammer, Blythewood, SC (US); Keith Schulz, Columbia, SC (US)

Correspondence Address: MCGUIREWOODS, LLP, 1750 TYSONS BLVD, SUITE 1800, MCLEAN, VA, 22102, US

(21) Appl. No.: 12/605,936

(22) Filed: Oct. 26, 2009

Related U.S. Application Data
(62) Division of application No. 10/897,173, filed on Jul. 23, 2004, now abandoned.

(51) Int. Cl. B05B 1/30

(52) U.S. Cl. 239/584

(57) ABSTRACT

An oil activated fuel injector includes a clevis having an optimized geometry. The optimized geometry substantially eliminates side loading effects of a plunger during operation, thereby maintaining performance integrity of the fuel injector. The optimized geometry includes a profile larger than a head portion of a plunger in order to allow the plunger to free float.

### BACKGROUND OF THE INVENTION

1. Field of the Invention

The invention generally relates to a fuel injector and to an optimized geometry of a clevis, and, more particularly, to a clevis having an optimized geometry for substantially eliminating side loading effects on a plunger during operation of the fuel injector, thereby maintaining fuel injector performance integrity.

2. Background Description

There are many types of fuel injectors designed to inject fuel into a combustion chamber of an engine. For example, fuel injectors may be mechanically, electrically or hydraulically controlled in order to inject fuel into the combustion chamber of the engine. In the hydraulically actuated systems, a control valve body may be provided with two, three or four way valve systems, each having grooves or orifices which allow fluid communication between working ports, high pressure ports, and venting ports of the control valve body of the fuel injector and the inlet area. The working fluid is typically engine oil or another type of suitable hydraulic fluid capable of providing pressure within the fuel injector in order to begin the process of injecting fuel into the combustion chamber.

In current designs, a driver will deliver a current or voltage to the open side of an open coil solenoid. The magnetic force generated in the open coil solenoid will shift a spool into the open position so as to align grooves or orifices (hereinafter referred to as “grooves”) of the control valve body and the spool. The alignment of the grooves permits the working fluid to flow into an intensifier chamber from an inlet portion of the control valve body (via working ports). The high-pressure working fluid then acts on an intensifier piston which pushes the plunger to compress fuel located within a high pressure fuel chamber. As the pressure in the high pressure fuel chamber increases, the fuel pressure will begin to rise above the needle check valve opening pressure. At the prescribed fuel pressure level, the needle check valve will lift against the needle spring and open the injection holes in a nozzle tip. The fuel will then be injected into the combustion chamber of the engine. The above process describes an injection event.

After an injection event, the driver will deliver a current or voltage to a closed side of the coil solenoid. The magnetic force generated in the closed coil solenoid will then shift the spool into a closed position, so as to align the grooves or orifices of the control valve body and the spool with a reservoir. At this time, the intensifier spring will force the plunger and piston upwards toward the working port to evacuate the working oil within the intensifier chamber to the reservoir via the working ports and aligned grooves. As the plunger moves upward, fuel is provided to the high pressure fuel chamber. This cycle is referred to as the return or fill stroke. After the high pressure fuel chamber is completely filled and the piston and plunger are stopped, the parts remain in this state until the next injection event. This cycle is referred to as a dwell time between injection events.

In the related art, as represented in FIG. 1, the loading force generated from the spring force is transferred to the plunger head 112A during the dwell time, return and injection event. This can cause side loading effects resulting in wear and scuffing of the plunger which, in turn, decreases the performance of the fuel injector. More specifically, FIG. 1 shows a piston 102 positionable within an intensifier chamber 100 and movable between a first position and a second position as indicated by arrow 104. A plunger head 112A is positionable within a receiving portion 114 of a clevis 110, and a spring 116 is positionable about the body portion 112B of the plunger 112 and an outer circumference of the clevis 110. The clevis 110 includes a shoulder 118 and a lip portion 120.

In the related art, the plunger head 112A is held tightly between the lip portion 120 of the clevis 110 and the piston 102, with no clearance. In this manner, during operation the spring force will act on the shoulder 118 of the clevis 110 where such force will be transferred to the lip 120 of the clevis 110. This spring force will then act on the plunger and create a side loading effect on the plunger 112 that results, over time, in removal or scuffing of a film on the plunger (e.g., 0 to 2 μm of film deterioration) and/or wear on the metal surfaces of both the plunger and wall of the intensifier chamber (e.g., up to 50 μm or more of wear). This is due to uneven spring forces generated on the shoulder 118 of the clevis 110. In the related art scuffing and/or wearing is caused by interaction between the spring 116 and the clevis 110 and results in an increased clearance or gap between the plunger 112 and the intensifier chamber wall. This results in pressure loss within the intensifier chamber; mixing of the fuel with oil, since fuel will be able to leak into a spring cavity and eventually into the cylinder head; loss of sealing capabilities; and an overall loss of injector performance. This ultimately leads to degradation of injector performance.

FIG. 2 shows a graphical representation of the fuel leak rate (cc/S) versus plunger clearance (μm) in a related art system. The curve represents experimental data collected from a related art injector collected over a predetermined testing period. These actual or observed results are far worse than the theoretical results calculated by the following equation. That is, in the related art fuel injectors a much higher fuel leak rate should be expected than predicted theory. More specifically, the equation below predicts results below the experimental data curve as shown in FIG. 2.

$$Q = \frac{π}{12} \frac{D \cdot {C}^{3}}{L \cdot ρ \cdot v} P$$

In this equation, D is diameter of the plunger, C is the radial clearance, L is the length of the plunger (flow path) in sealing region, ρ is the density of the fluid, ν is the kinematic viscosity of the fluid, and P is the pressure. Comparing the experimental results to the theoretical results, it can be determined that the experimental results are far worse than predicted. For example, at a plunger clearance of 30 μm the equation indicates a fuel leak rate of approximately a 0.5 cc/s, whereas experiments demonstrate an actual fuel leak rate of approximately 2.8 cc/s. Accordingly, there is a need for an improved injector that minimizes or eliminates the disadvantages of the related art.

The invention is directed towards overcoming one or more of the problems and disadvantages of the related art.

### SUMMARY OF THE INVENTION

In an aspect of the invention an apparatus is provided that substantially eliminates side loading effects on a plunger. For example, a clevis is provided having a geometry which substantially eliminates side loading effects on a plunger during operation. In another aspect of the invention a device comprises a clevis having a geometry that substantially eliminates frictionally induced deterioration on a body portion of a plunger.

In a further aspect of the invention, an injector structure comprises a piston, a plunger including a first portion and a second portion, and a clevis. The clevis comprises a structure in communication with a first portion of the plunger, wherein the clevis structure substantially eliminates side loading effects generated from a spring force being transferred to the plunger during operation.

In another aspect of the invention, a fuel injector comprises a body control valve having an inlet port and working ports. At least one solenoid coil is positioned at an end or ends of the body control valve and an intensifier chamber. Alternatively, a solenoid and/or spring can provide the desired opposing forces. The intensifier chamber comprises a piston, a plunger having a first portion and a second portion, a spring positionable substantially about the second portion of the plunger, and a clevis having a receiving portion. Further, the receiving portion has a profile which allows the plunger to free float therein. A contacting portion moves the piston from a first position to a second position during a return time between injection events via a spring loading force exerted on the loading portion of the clevis. A high pressure fuel chamber is arranged below the second portion of the plunger and a needle chamber having a needle responsive to an increased fuel pressure created in the high pressure fuel chamber.

In yet another aspect of the invention, a device comprises a means for substantially eliminating side loading effects on a plunger during operation and a biasing means contacting the eliminating means. The biasing means moves a piston from a first position to a second position.

### BRIEF DESCRIPTION OF THE DRAWINGS

FIG. 1 shows a cross-sectional view of a portion of a fuel injector during a dwell time between injection events according to the related art;

FIG. 2 shows a graph illustrating data according to the related art;

FIG. 3A shows a perspective view of a clevis according to an embodiment of the invention;

FIG. 3B shows a cross-sectional view of FIG. 3A along line A to A′ with a plunger;

FIG. 3C shows a top down view of FIG. 3A with a plunger;

FIG. 3D shows a cross-sectional view of a clevis and plunger and piston assembly according to another embodiment of the invention;

FIG. 3E shows a cross-sectional view of a clevis and plunger and piston assembly according to another embodiment of the invention;

FIG. 4A shows a perspective view of a clevis according to another embodiment of the invention;

FIG. 4B shows a cross-sectional view of FIG. 4A along line B-B′;

FIG. 5A shows a perspective view of a clevis according to another embodiment of the invention;

FIG. 5B shows a cross-sectional view of FIG. 5A along line B to B′ with a plunger and piston assembly;

FIG. 6 shows a cross-sectional view of a portion of a fuel injector during a dwell time between injection events according to the invention;

FIG. 7 shows a graph illustrating data according to the invention; and

FIG. 8 shows a cross-sectional view of a fuel injector assembly according to the invention.

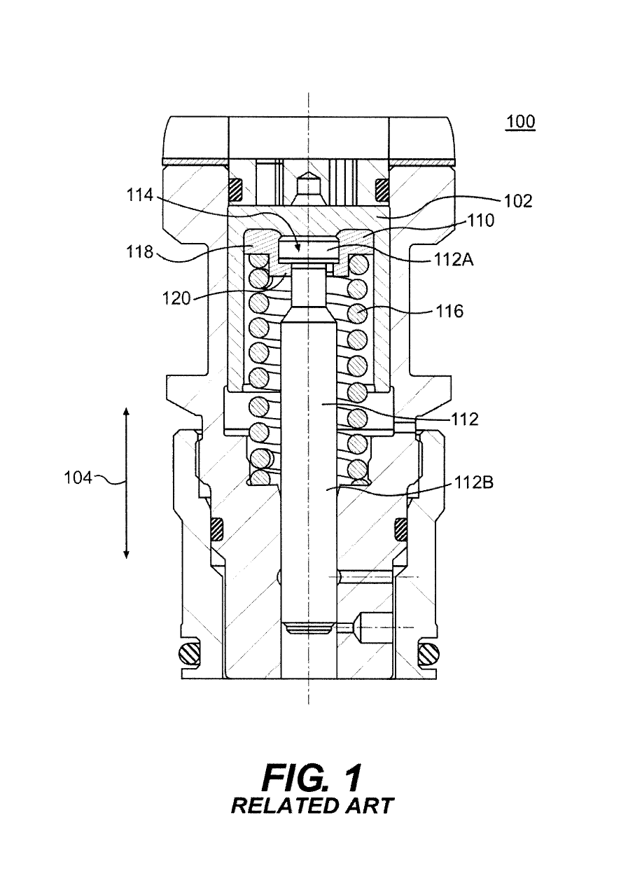

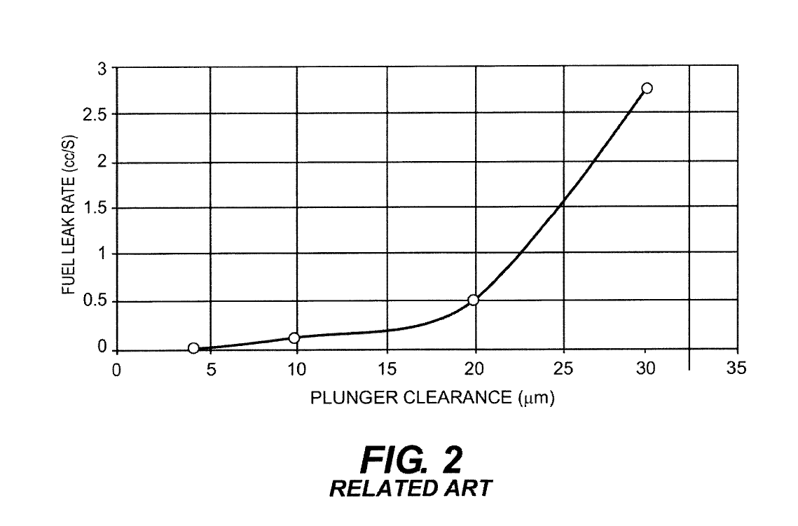

### DETAILED DESCRIPTION OF A PREFERRED EMBODIMENT OF THE INVENTION

The invention is directed to an oil-activated electronically, mechanically or hydraulically controlled fuel injector, including a clevis having an optimized geometry for maintaining the performance integrity of the fuel injector. This geometry substantially prevents or eliminates scuffing of a film on a plunger, as well as metal-to-metal (or alloy) wear on the plunger and intensifier chamber. The substantial prevention or elimination of scuffing and/or wearing reduces or prevents fuel leaking and maintains performance integrity of the fuel injector. This is accomplished by allowing the plunger to “free float” within the clevis; that is, an optimized geometry of the clevis of the invention substantially eliminates side loading effects on the plunger, thereby maintaining performance integrity of the fuel injector.

### Embodiments of the Oil-Activated Fuel Injector of the Invention

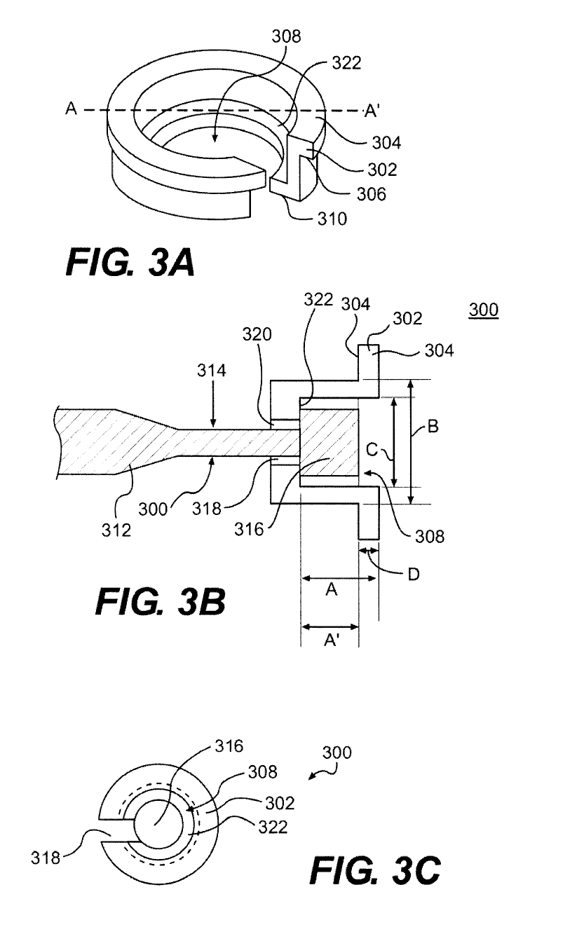

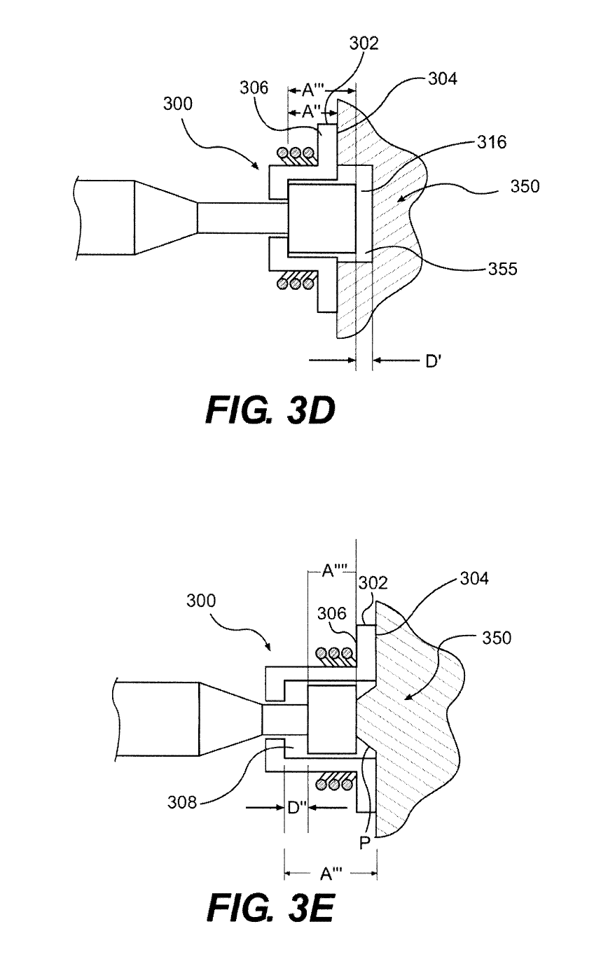

FIG. 3A shows a perspective view of a clevis according to an embodiment of the invention. Referring to FIG. 3A, a clevis is generally depicted as reference numeral 300. The clevis 300 includes a shoulder portion 302 having a contacting portion or surface 304 for contacting a piston (not shown) and a loading portion 306 for receiving spring forces. A receiving portion 308 is capable of receiving a portion of the plunger (not shown). The clevis 300 further includes an optional lip portion 310 including an upper surface 322 for contacting a portion of the plunger (not shown) during a low or no fuel condition. The clevis includes an optimized geometry, which is a profile or height measured by the distance between the upper surface 312 and the shoulder 304, in embodiments.

FIG. 3B shows a cross-sectional view of FIG. 3A along line A to A′. Referring to FIG. 3B, the clevis 300 includes the shoulder 302 having a contacting portion 304 for contacting a piston portion (not shown) and a loading portion 306 for receiving a spring (not shown). The clevis has a height A measured from an inside surface of the clevis, an inner circumference C, and an outer circumference B. The height A is set to be greater than a height of the plunger head A′, thereby leaving a distance D in the receiving portion 308. The distance D can range from about 0 mm or higher, for example, in a range from about 0.5 mm to 1.0 mm or higher. The distance is set to substantially eliminate side loading effects on the plunger during operation of the injection by preventing the spring force from acting on the plunger. In other words, the distance D allows for the plunger to be “free floating.”

Additionally, as shown in FIG. 3B, the plunger 310 includes a body portion 312, a neck portion 314, and a head portion 316 (plunger head). The neck portion 314 may have a smaller diameter than the remainder of the plunger head 316 and the body portion 312, thereby allowing the neck portion 314 to pass through the opening 318 or slit of the clevis, and more particularly, allowing the plunger head 316 to be arranged within the receiving portion 308 of the clevis 300. Optionally, the plunger 310 may have a substantially uniform diameter if desired, depending on the geometry of an optional lip 320 portion of the clevis 300. The lip portion includes an upper surface 322 or contact portion capable of supporting a lower portion of the plunger head 316 during low fuel or no fuel conditions.

The plunger head 316 is arranged between the sidewalls of the clevis 300. For example, the plunger head 316 is arranged inside the inner circumference portion of the clevis 300. A portion of the spring (not shown) is arranged along an outer circumference of the clevis and in contact with the loading portion 306 of the shoulder 302. It should be understood that the clevis may take on any geometry in order to substantially eliminate side loading effects of a plunger assembly during operation and, in one aspect, a non-injection event.

FIG. 3C shows a top down view of FIG. 3B. As shown, the clevis 300 has a shoulder 302 with a contacting surface 322| for contacting the plunger, a top portion of the plunger head 316, and a receiving portion 308 for receiving the plunger head 316. The opening 318 or slit allows the plunger neck 314 to be inserted into the receiving portion 308, thereby the plunger head 316 can be arranged inside the receiving portion 308.

FIG. 3D shows a cross-sectional view of the clevis according to another embodiment of the invention. In this embodiment, the clevis 300 includes a shoulder 302 having a top contacting surface 304 which contacts a portion of the piston 350. The clevis further includes a loading portion 306 for receiving a spring. The clevis has a height A″ measured from an inside surface| 322 of the clevis to the top contacting surface 304. In this embodiment, the height A″ is less than a height of the plunger head A′″; however, due to the offset space 355 of the plunger a distance D′ remains between an upper surface of the piston 350 and an upper surface of the plunger head 316. The distance D′ may range from about 0 mm or higher, for example, in a range from about 0.5 mm to 1.0 mm or more, and is set to substantially eliminate side loading effects on the plunger during operation of the injection. This is accomplished by preventing the spring force from acting on the plunger itself (e.g., the distance D′ allows for the plunger to be “free floating”). The offset space may be designed in any geometry to allow the plunger to be “free floating.”

FIG. 3E shows a cross-sectional view of clevis according to another embodiment. In this embodiment, a protruding portion “P” of the piston is designed to sit within a portion of the clevis. The clevis 300 includes a shoulder 302 having the top contacting surface 304 that contacts the piston portion and a loading portion 306 for receiving a spring. In this embodiment, the clevis has a height A′″ measured from an inside surface of the clevis 300 to the top contacting surface 304. The height A′″ is set to be greater than a height of the plunger head A″″, thereby leaving a distance D″ in the receiving portion 308. The distance D″ can range from about 0 mm or higher, for example, in a range from about 0.5 mm to 1.0 mm or more and is set to a length that substantially eliminates side loading effects on the plunger during operation of the injection. This is accomplished by preventing the spring force from acting on the plunger itself. However, in this embodiment the height A′″ will be greater than the combination of the protruding portion and the plunger head to provide the amount offset space to allow the plunger to be “free floating.”

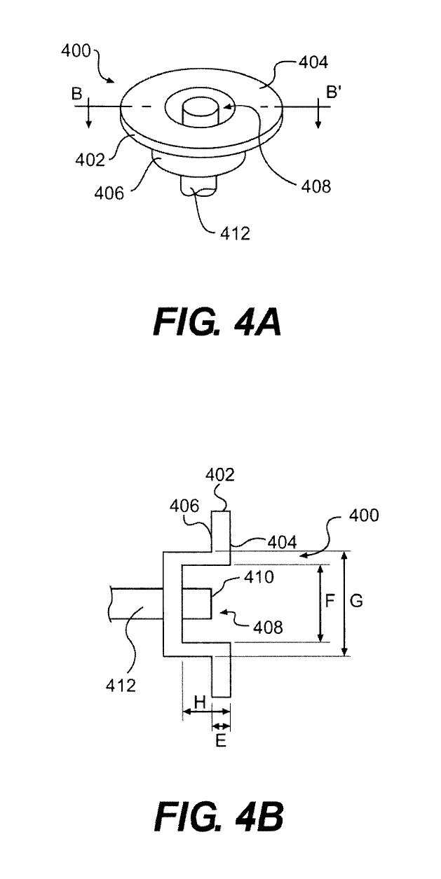

FIG. 4A shows a perspective view of a clevis according to another embodiment of the invention. Referring to FIG. 4A, the clevis of this embodiment is generally depicted as reference numeral 400. The clevis 400 includes a shoulder portion 402 having a contacting portion 404 for contacting a piston and a loading portion 406 for receiving spring forces. A receiving portion 408 is formed in an inner portion of the clevis 400 and receives a portion of the plunger (not shown).

FIG. 4B shows a cross-sectional view of FIG. 4A along line B to B′ according to another embodiment of the invention. In this view it is seen that the shoulder portion 402 includes the contacting portion 404 for contacting a piston (not shown) and the loading portion 406 for accepting the spring force of a spring. The clevis has a height H measured from an inside surface of the clevis to an upper surface, an inner circumference F, and an outer circumference G. The height H is set to be greater than the plunger head 410 when the plunger 412 is arranged inside the receiving portion 408 of the clevis 400, thereby leaving a distance E measured from a top portion of the plunger head 410 to a top surface of a contacting portion 404 of clevis 400. The distance E may be in a range from about 0 mm or higher, for example, in a range from about 0.5 mm to 1.0 mm or higher. The distance is set to substantially eliminate side loading effects of a plunger assembly during operation of the fuel injector. It should be understood that the clevis may take on any geometry in order to substantially eliminate side loading effects of a plunger assembly during operation and, in one aspect, a non-injection event.

In this configuration there is no slit or opening as in the previous embodiments. As a result, the plunger 408 may have a substantially uniform diameter throughout. The plunger head 410 is arranged in the receiving portion 408 of the clevis 400 by inserting the plunger through the receiving portion 408. Accordingly, the plunger is configured to have a smaller diameter than the inner circumference F of the clevis 400 to allow for movement of the plunger. Optionally, the diameter of the plunger does not have to be substantially uniform. For example, the plunger 408 may have a neck portion as previously described in foregoing embodiments.

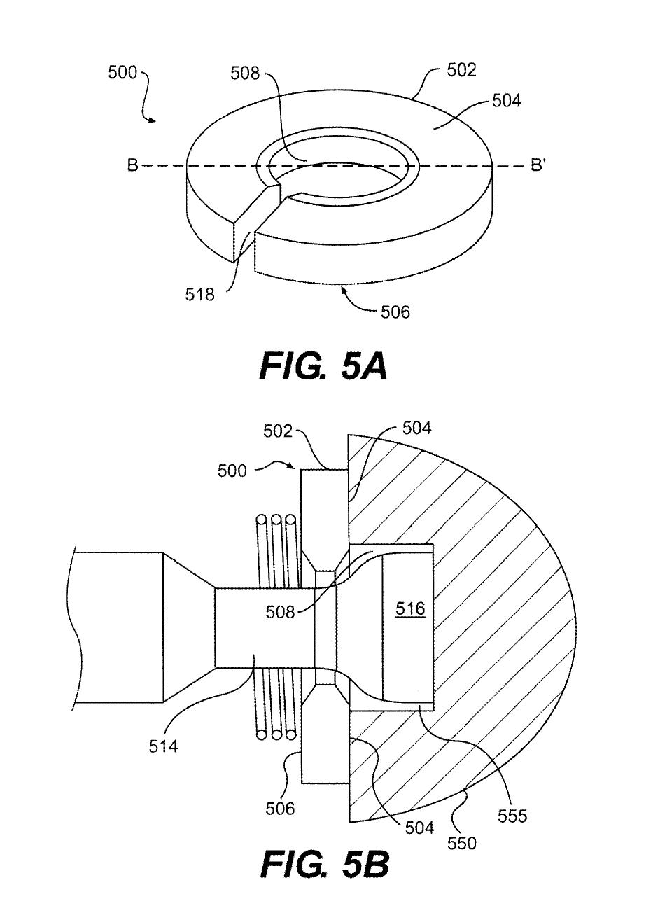

FIG. 5A shows a perspective view of a clevis according to an embodiment of the invention. Referring to FIG. 5A, the clevis is generally depicted as reference numeral 500 and includes a shoulder portion 502 having a contacting surface 504 for contacting a piston (not shown), and a loading portion 506 for receiving spring forces. In this embodiment, the clevis 500 has a ring shape with a slit or opening 518. A receiving portion 508 is designed to receive a portion of the plunger. The opening or slit 518 allows the plunger neck 514 to be inserted therethrough into the receiving portion 508. The contacting surface 504 may contact a portion of the plunger (not shown) in low or no fuel conditions. Optionally, a portion of the inner circumference of the ring may be beveled.

FIG. 5B shows a cross-sectional view of FIG. 5A along line B to B′ with a plunger and piston assembly. The top contacting surface 504 of the clevis contacts a portion 550 of the piston. The loading portion 506 receives the spring, and the opening 518 allows the plunger neck 514 to be inserted therethrough into the receiving portion 508. The piston 525 is designed to have an offset portion 555 over at least a portion of the plunger head 516. In this embodiment, the plunger head 516 is arranged inside the offset portion 555 of the piston 525|. The offset portion 555 is set to a distance that is larger than the height of the plunger head 516. Also, the offset portion 555 is designed to allow for the plunger to be “free floating” by having the spring force applied only to the surface 506.

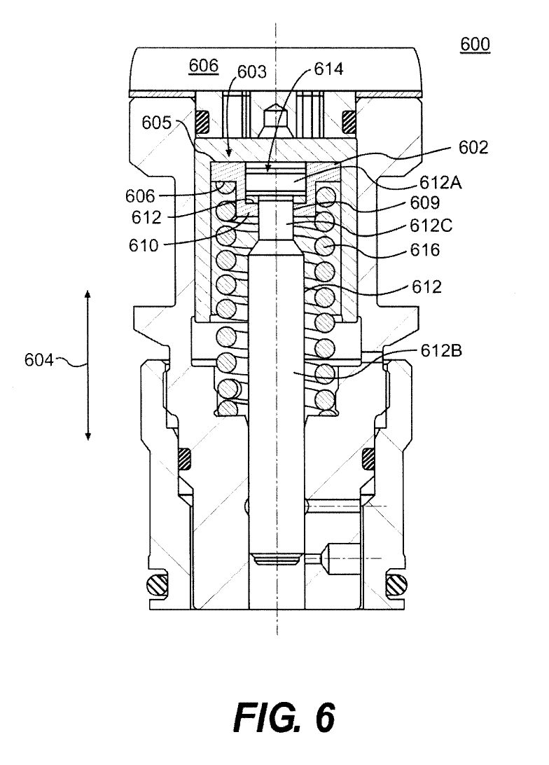

FIG. 6 shows a cross-sectional view of a portion of a fuel injector during a dwell time between injection events in accordance with the invention. In FIG. 6, the intensifier chamber is generally depicted as reference 600. A piston 602 is positionable within the intensifier chamber 600 and is movable between a first position and a second position as indicated by arrow 604. As represented in FIG. 6, immediately prior to an injection event the piston 602 is positioned proximate to a control valve assembly 606.

Still referring to FIG. 6, the intensifier chamber 600 further houses the clevis of the invention and a plunger 612. The plunger 612 includes a plunger head 612A, a plunger body 612B, and a plunger neck 612C. The plunger head 612A is positionable within a receiving portion 614 of the clevis 603|. A spring 616 is provided within the intensifier chamber 600, and, more particularly, is positionable about the body portion 612B of the plunger 612 and an outer circumference of the clevis 603. In one aspect of the invention, the spring 616 is positioned within an inner bore of the piston 602.

The clevis 603 may include a shoulder portion 602 with loading portion 606 for receiving spring forces and a contact portion 605 for contacting a piston 602. A receiving portion 614 is capable of receiving a portion of the plunger head 612A. The clevis 603 further includes an optional lip portion 610 including an upper surface 612 for contacting a portion of a plunger during a low or no fuel condition. The clevis 603 includes an optimized geometry having a profile or height measured by the distance between the upper surface 612 and the upper surface of the contact portion 605.

In implementation, the profile of the clevis (e.g., the substantially vertical wall between the shoulder and lip portion) is greater than a head portion 612A of the plunger 612. In this manner, the plunger 612 is free floating within the intensifier chamber 600, and more particularly, within the receiving portion 614 of the clevis. As discussed in detail, the profile of the clevis in relation to the head portion 612A of the plunger 612 substantially eliminates or prevents wear and/or scuffing of the plunger body 612B, as well as wear and/or scuffing on the wall of the intensifier chamber during a dwell time between injection events and during an injection event.

Optionally, as discussed, the clevis 603 may have an opening or slit portion 609 for receiving a head portion 612A of the plunger, and a neck portion 612C of the plunger 612. In this configuration, the neck portion 612C has a smaller diameter than the rest the plunger 612 and the opening 609. The neck portion 612C is inserted into the opening or slit portion 609 allowing the plunger head 612A to be arranged within the receiving portion 614 of the clevis 603.

Alternatively, the head portion 612A, neck portion 612C, and body portion 612B of the plunger 612 may have substantially the same diameter, as described with reference to FIGS. 4A-4C. The diameter of the plunger may depend on whether a lip is utilized. For example, if no lip is provided the plunger may have a substantially uniform diameter allowing the head portion 612A to be positionable within the clevis. It should be understood that the geometry and the piston as described in any of the embodiments may be mixed and matched to form the fuel injector assembly. For example, the piston with the offset portion may be utilized with any of the clevis geometries described herein.

Additionally, the invention may be a replacement kit for a fuel injector assembly. For example, a replacement kit includes the clevis having an optimized geometry for substantially eliminating side loading effects on a plunger. The kit may include a replacement plunger configured to operate with the replacement clevis and original injector. That is, by using the replacement kit on a used injector, it can be modified to ensure that there is substantially no deterioration in performance after a period of use of operation (e.g., injection events). Optionally, boring and/or resurfacing the intensifier chamber may be utilized to ensure proper tolerances between the plunger and the intensifier chamber. Additionally, the boring will substantially eliminate any damage which may have occurred to the intensifier chamber.

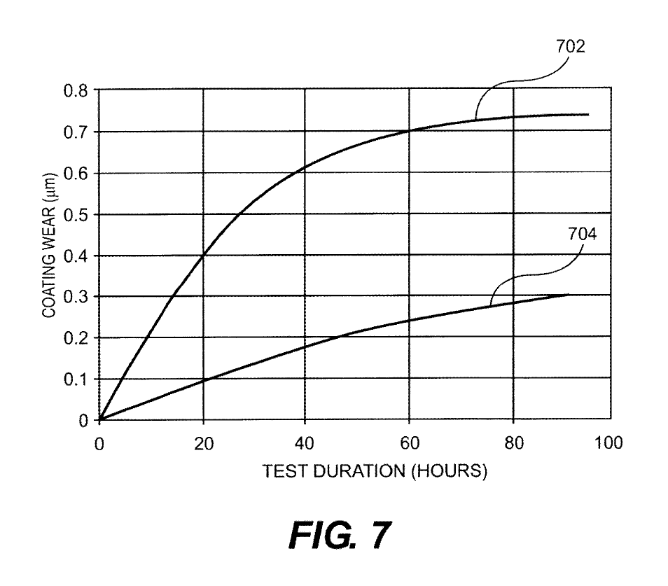

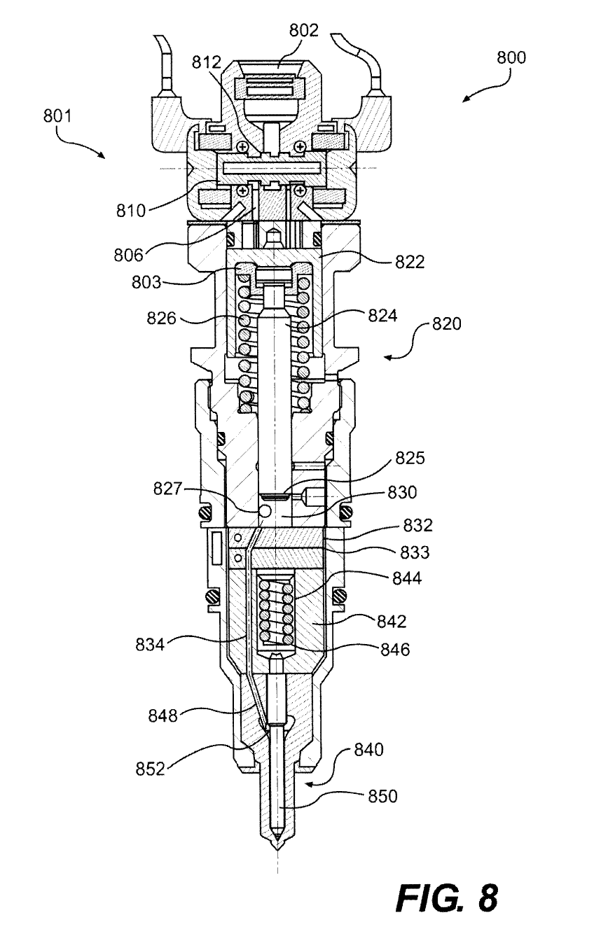

FIG. 7 shows a graph illustrating data according to the invention. FIG. 7 graphs coating wear (μm) versus test duration (hours). This graph shows a conventional fuel injector as curve 702 and a fuel injector according to the invention as curve 704. The injector according to aspects of the present invention has substantially less scuffing and/or wearing over time than that of a conventional injector. Accordingly, the injector of the invention has superior performance over time as compared to the conventional injector. As previously discussed and illustrated in this graph, the conventional injector has side loading effects causing scuffing and/or wearing because of interaction between the spring and the clevis. This results in an increased clearance or gap between the plunger and the intensifier chamber wail. This in turn results in pressure loss within the intensifier chamber, mixing of the fuel with oil due to allowing fuel to leak into a spring cavity and eventually into the cylinder head, loss of sealing capabilities, and ultimately overall loss of injector performance. As shown by this graph, the invention overcomes one or more of the problems and disadvantages as set forth above by substantially eliminating scuffing and/or wear.

### Operation of the Oil Activated Fuel Injector of the Invention

FIG. 8 shows an overall view of the fuel injector assembly 800. The intensifier body 820 is mounted to a valve control body 801 via any conventional mounting mechanism. A piston 822 is slidably positioned within the intensifier body 820 and is in contact with an upper end of a plunger 824. An intensifier spring 826 surrounds a portion (e.g., shaft) of the plunger 824 and is further positioned between the clevis 803 and a flange or shoulder formed on an interior portion of the intensifier body 820. The intensifier spring 826 urges the piston 822 and the plunger 824 in a first position proximate to the valve control body 801. In general, a high-pressure chamber 830 is formed by an end portion 825 of the plunger 824 and an interior wall 827 of the intensifier body 820. A fill path 833 provides fuel into the high-pressure chamber 830 via a fuel inlet 832.

The nozzle generally depicted as reference numeral 840 is in fluid communication with the high-pressure chamber 830 via a fuel bore 834. It should be recognized that the fuel bore 834 may be straight or angled or at other known configurations. Upon fuel compression into the high-pressure chamber 830, fuel flows from the high-pressure chamber 830 to the nozzle 840. A spring cage 842 (which may be a separate component from the nozzle 840)|, which typically includes a centrally located bore, is bored into the nozzle 840. A spring 844 and a spring seat 846| are positioned within the centrally located bore of the spring cage 842. The nozzle 840 further includes a discharge path 848 in alignment with the fuel bore 834. A needle 850 is preferably centrally located with the nozzle 840 and is urged downwards by the spring 844. A fuel chamber 852 surrounds the needle 850 and is in fluid communication with the discharge path 848.

In operation, a driver (not shown) will first energize the coil and in this position the working fluid pressure within the pressure chamber 830 should be much lower than the rail inlet pressure. The energized coil will then shift the spool 810 to an open position. In one embodiment, a coil and opposing spring can provide forces to move the spool. In the open position, the groove 812 will overlap with the bore and the cross bore (not shown in detail.) This will allow the working fluid to flow between the inlet port 802 and the intensifier chamber via the working port 806, and simultaneously seal the vent port.

During an injection event the pressurized working fluid is allowed to flow into the working port 806 where it begins to act on the piston and the plunger. That is, the pressurized working fluid will begin to push the piston and the plunger downwards, compressing the intensifier spring. As the piston is pushed downward, fuel in the high pressure fuel chamber will begin to be compressed via the end portion of the plunger. A quantity of compressed fuel will be forced through the bores into the heart chamber which surrounds the needle. As the pressure increases, the fuel pressure will rise above the needle check valve opening pressure until the needle and needle spring are urged upwards. At this stage, the injection holes in the nozzle are open allowing a main fuel quantity to be injected into the combustion chamber of the engine. During this event, the spring forces will act on the clevis, and not exert any a side loading force on the plunger|.

To end the injection event and start a non-injection event, the driver will energize the closed coil. The magnetic force generated in the coil will then shift the spool 810 into the closed position, which will offset the groove from the cross bore. This will open the vent port and allow fluid to flow from the intensifier chamber through the vent port. Also, the inlet port 802 will no longer be in fluid communication with the bore (and intensifier chamber). The working fluid within the intensifier chamber will then be vented to ambient pressure and the needle spring will urge the needle downward towards the injection holes of the nozzle thereby closing the injection holes. Similarly, the intensifier spring will exert a force on the clevis for urging the plunger and the piston into the closed or first position adjacent to the valve.

During this time, the plunger will move upward by forces in the high pressure chamber and fuel will again begin to flow into the high-pressure chamber of the intensifier body. Also, the spring forces will act on the clevis in order to move the piston from a first position to a second position. However, as discussed above, due to the geometry of the clevis and the clevis allowing the plunger to free float, no spring forces or loads will be transferred to the plunger, substantially eliminating side loading effects on the plunger during the non-injection event. This prevents or eliminates scuffing and wear of the plunger thus maintaining the performance integrity of the fuel injector.

While the invention has been described in terms of preferred embodiments, those skilled in the art will recognize that the invention can be practiced with modification within the spirit and scope of the appended claims.

1-40. (canceled)

41. A fuel injector assembly, comprising:
a plunger comprising a head portion having a first height; and
a clevis for engaging the plunger, the clevis comprising:
a sidewall having a cylindrical shape surrounding a receiving space of the clevis, the receiving space configured to receive the head portion of the plunger and having a second height greater than the first height;
a shoulder portion extending outwardly from an upper portion of the sidewall, the shoulder portion comprising a contacting portion and a loading portion;
a lip portion extending inwardly from a lower portion of the sidewall; and
a slit extending across the shoulder portion, the sidewall and the lip portion to allow at least a portion of the plunger to pass therethrough to the receiving space.

42. The fuel injector assembly of claim 41, wherein the shoulder portion and lip portion comprise a circular shape.

43. The fuel injector assembly of claim 42, wherein the shoulder portion comprises:
an upper surface comprising the contact portion; and
a lower surface comprising the loading portion.

44. The fuel injector assembly of claim 42, wherein the plunger further comprises a neck portion attached to the head portion of the plunger.

45. The fuel injector assembly of claim 44, wherein the neck portion has a diameter smaller than that of the head portion of the plunger to pass through the slit of the clevis.

46. The fuel injector assembly of claim 41, further comprising an open space in the receiving space of the clevis between an upper surface of the plunger and the upper surface of the shoulder portion.

47. A fuel injector assembly, comprising:
a plunger having a head portion; and
a clevis configured to engage the plunger, the clevis comprising:
a contacting portion;
a loading portion; and
a receiving portion configured to receive the head portion of the plunger, the receiving portion having a height greater than a height of the head portion of the plunger.

48. The fuel injector assembly of claim 47, wherein the clevis substantially eliminates side loading effects on the plunger during an operation.

49. The fuel injector assembly of claim 48, wherein the operation comprises a dwell time between injection events.

50. The fuel injector assembly of claim 48, wherein the operation comprises:
an injection event;
a return event; or
a fill event.

51. The fuel injector assembly of claim 47, wherein the clevis comprises a ring shape.

52. The fuel injector assembly of claim 47, further comprising a piston,
wherein the contacting portion of the clevis is configured to move the piston from a first position to a second position during a return time between injection events via a spring loading force exerted on the loading portion of the clevis.

53. The fuel injector assembly of claim 47, wherein the clevis further comprises a shoulder.

54. The fuel injector assembly of claim 53, wherein the clevis further comprises a lip.

55. The fuel injector assembly of claim 54, wherein the shoulder and the lip are on opposing surfaces of the clevis.

56. The fuel injector assembly of claim 47, wherein the clevis further comprises a slit to receive a portion of the plunger.
